(19) United States
(12) Patent Application Publication
(10) Pub. No.: US 2005/0135332 A1
(43) Pub. Date: Jun. 23, 2005

(54) Automatic internet communication device

(76) Inventor: Shiang-Yi Tsai, Taipei City (TW)

Correspondence Address: Shiang-Yi Tsai, P.O. Box No. 6-57, Junghe, Taipei, 235, TW

(21) Appl. No.: 10/736,669

(22) Filed: Dec. 17, 2003

(51) Int. Cl. H04L 12/66

(52) U.S. Cl. 370/352

(57) ABSTRACT

An automatic internet communication device, characterized in a configuration having a mouthpiece, which facilitates connection to input/output ports of intermediary terminals of a computer including a keyboard, a mouse, a USB port or a microphone. Upon an on-line communication system or software administrative staff linking-up, a small window appears on the computer monitor of recipient prompting the recipient for a response, and by simply picking up the mouthpiece self-actuates a tact switch signal to execute functioning from a central control center, thereupon establishing on-line network communication. The mouthpiece can also utilize input/output terminals of a computer to draw on a power supply and effect signal input/output transmission, thereby accomplishing wireless transmission The mouthpiece is further designed to hang on either side of the computer monitor, or independently set aside, and is further configured with a switch that provides a cutover device for accepting or refusing on-line communication.

### BACKGROUND OF THE INVENTION

(a) Field of the Invention

The present invention relates to an Automatic internet communication device, particularly to network on-line communication through a mouthpiece. The Automatic internet communication device thereby furnishes on-line network communication proceedings with a human touch.

(b) Description of the Prior Art

According to a conventional method of network on-line communication, upon administrative staff linking up, although a prompt message will appear on the recipient's computer monitor of a signal recipient, when the signal recipient decides to accept communication, the signal recipient must first use a mouse to execute connection command in the message dialogue box in order to accept on-line communication, and by means of related communication devices (such as a microphone, a speaker, etc.) thereby establish two-way communication with an out-going message. This method is not only troublesome to operate, but also, may not be noticeable to the recipient while box hence important messages may be missed as a consequence. This conventional method for Internet on-line communication is thus markedly deficient.

### SUMMARY OF THE INVENTION

The primary objective of the present invention is to provide an Automatic internet communication device, which facilitates Internet communication by means of a mouthpiece, and thereby effectuate a functionality to accept or hang up in-coming communication signals, providing a human touch to communication proceedings.

The aforementioned Automatic internet communication device, wherein is configured with a mouthpiece, which is enabled by connection to input/output ports of intermediary terminals of a computer including keyboard, mouse, USB port, or microphone. Upon receiving a signal the recipient, simply picks up the mouthpiece which self-actuates a tact switch to execute functioning from a central control center, and thereupon establish on-line network communication.

Upon an on-line communication system or software administrative staff linking-up, the aforementioned Automatic internet communication device launches a small window on the computer monitor, thereby prompting the recipient for response.

The aforementioned Automatic internet communication device, where the mouthpiece includes an in-coming signal prompt device, and upon an in-coming signal calling the recipient, the in-coming signal triggers device auto-runs a music prompt. Moreover, the user can set time period the music prompt plays and adjust sound volume, as well as self-record or edit whatever sound the user wishes the music prompt to play.

The aforementioned Automatic internet communication device, where the mouthpiece and a keyboard can be configured as a single unit, and through input/output resources of the keyboard provides required electric power.

The aforementioned Automatic internet communication device, where the mouthpiece can be configured for wireless transmission, thereby actualizing two-way transmission between a transmitter terminal and a receiver terminal.

The aforementioned Automatic internet communication device, where the mouthpiece is configured with a switch, therewith providing a cutover device for accepting or refusing on-line communication.

To enable further understanding of the said objectives and the technological methods of the invention herein, brief description of the drawings below is followed by the detailed description of the preferred embodiments.

### BRIEF DESCRIPTION OF THE DRAWINGS

FIG. 1 shows a block diagram according to the present invention.

FIG. 2 shows a block diagram of an embodiment of an in-coming signal prompt block diagram according to the present invention.

FIG. 3 shows a block diagram of a mouthpiece and a keyboard configured as a single unit according to the present invention.

FIG. 4 shows a block diagram of the mouthpiece and the keyboard configured for wireless transmission according to the present invention.

### DETAILED DESCRIPTION OF THE PREFERRED EMBODIMENTS

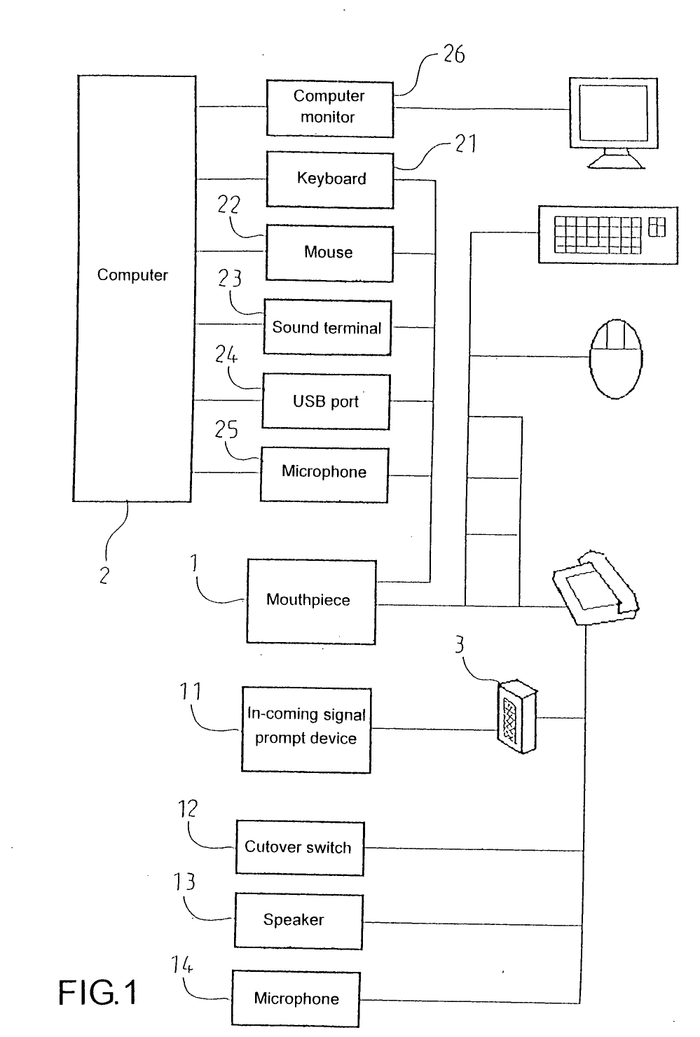

Referring to FIG. 1, which shows a block diagram of the present invention, characterized in a configuration having a mouthpiece 1, which is enabled through connection to input/output ports of intermediary terminals of a computer 2 including a keyboard 21, a mouse 22, a sound terminal 23, a USB port 24, and a microphone 25. The mouthpiece 1 comprises an in-coming signal prompt device 11, a cutover switch 12, a speaker 13 and a microphone 14, and the mouthpiece 1 is further enabled to connect to an amplifier 3. The mouthpiece 1 facilitates self-actuating a tact switch signal to execute functioning from a central control center, and thereupon establish on-line network communication.

An Automatic internet communication device is thus constructed and assembled from aforementioned components. Upon an on-line network communication system or software administrative staff linking-up, the following steps disclose procedures to actualize communication:

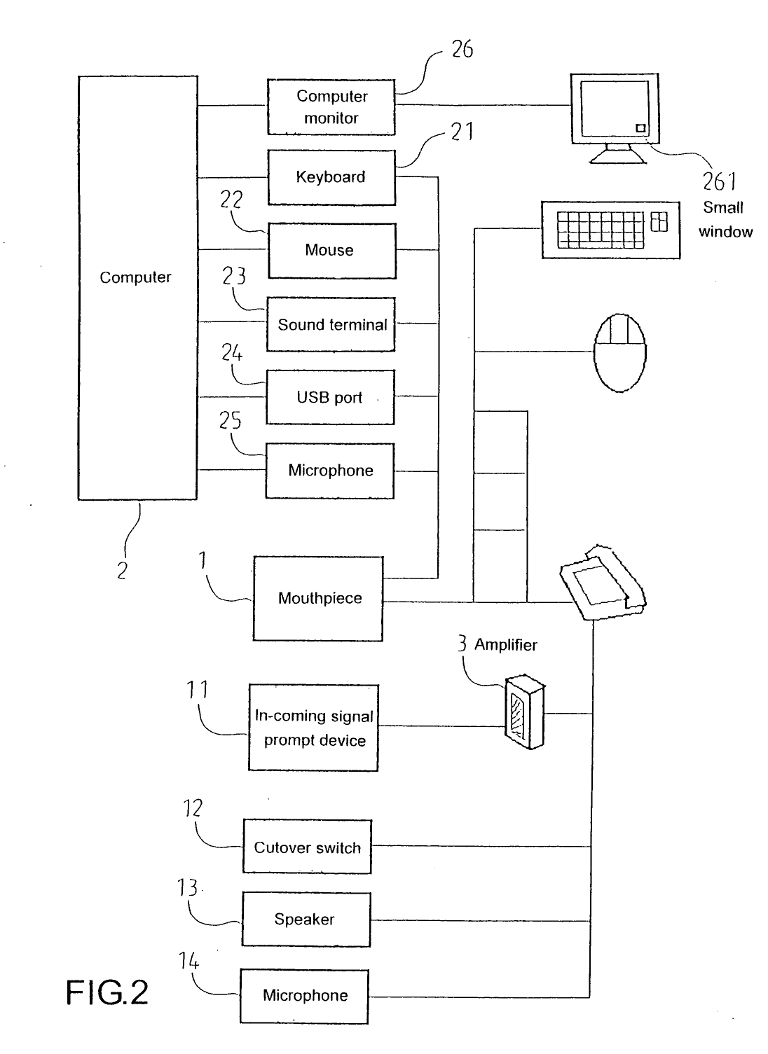

1. A small window 261 appears on a computer monitor 26 of recipient, thereby prompting the recipient to accept or refuse on-line communication (see FIG. 2).

2. If the recipient is willing to communicate on-line, then picking up the mouthpiece 1 auto-runs a small window showing acceptance options, which are to either accept establishing on-line network communication or refuse.

3. Upon effecting aforementioned step 1, the in-coming signal prompt device 11 simultaneously automatically triggers a music prompt configured in the on-line communication system, and shuts off any other sound already playing, a user can set time period the music prompt plays as well as record or edit whatever sound the user wishes the music prompt to play.

The present invention is operated entirely on-line for real-time communication, commensurate with providing a human touch to the on-line communication system, as well as providing the on-line communication system wherewith important information is never lost.

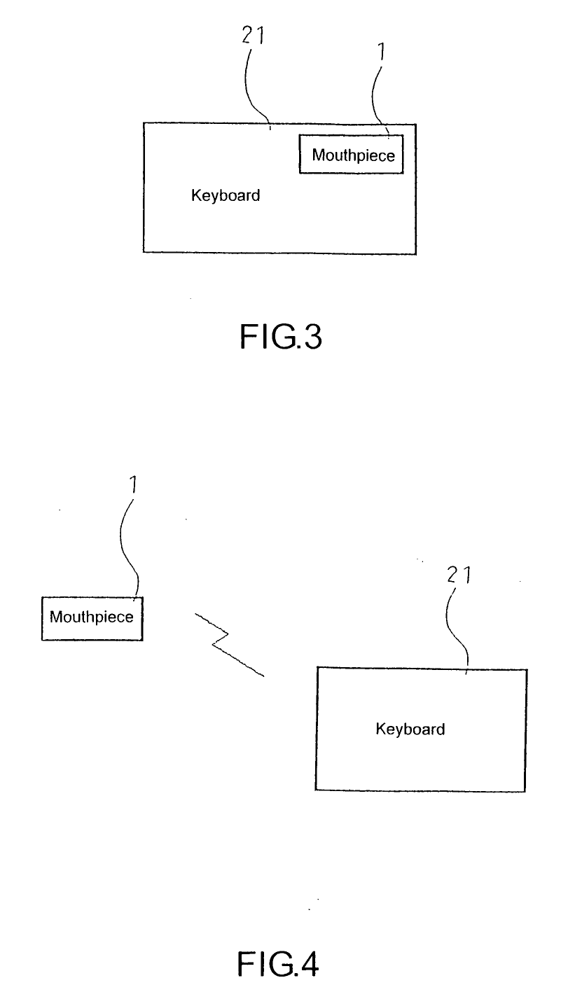

Referring to FIG. 3, which shows a block diagram of the mouthpiece 1 and the keyboard 21 configured as a single unit according to an embodiment of the present invention, thereby disclosing that the mouthpiece 1 of the present invention and the keyboard 21 can be configured as a single unit, at the same time as an input/output resource already installed in the keyboard 21 which provides required electric power, and thus furnishing even greater convenience in usage. A wireless transmission method can also be implemented to enable communication between the mouthpiece 1 and the keyboard 21 (see FIG. 4), whereby the keyboard 21 is configured as a transmitter terminal, and the mouthpiece 1 is configured as a receiver terminal, thereby allowing the user to proceed with the on-line network communication when moving around. Furthermore, the cutover switch 12 can be configured on the mouthpiece 1, thereby enabling cutover of accepting or refusing the on-line network communication link-up. The mouthpiece 1 is further designed to hang on side of computer monitor 26, set by the keyboard or to independently hang.

In conclusion, the present invention enables connecting the mouthpiece 1 with computer peripheral equipment, and thereby enables convenient on-line communication, and is commensurate with providing a human touch to on-line communication. The present invention realizes a functional design, and discloses a new and original invention. Accordingly, a patent application is proposed herein.

It is to be understood that the embodiments described herein is merely illustrative of the principles of the invention and that a wide variety of modifications thereto may be effected by persons skilled in the art without departing from the spirit and scope of the invention as set forth in the following claims.

1. An automatic internet communication device, characterized in a configuration having a mouthpiece, which is enabled through connection to input/output ports of a computer, whereby, upon an on-line communication system or software administrative staff linking-up, the mouthpiece actualizes convenience of establishing on-line network communication.

2. The automatic internet communication device as claimed in claim 1, wherein the mouthpiece comprises an in-coming signal prompt device, which triggers a music prompt upon receiving an in-coming signal, and allows a user to set time period the music prompt plays as well as adjust sound volume, and record or edit whatever sound the user wishes the music prompt to play.

3. The Automatic internet communication device as claimed in claim 1, wherein the mouthpiece and a keyboard are configured as a single unit, and an input/output resource of the keyboard provides required electric power.

4. The automatic internet communication device as claimed in claim 1, wherein the keyboard and mouthpiece are configured as a transmitter terminal and a receiver terminal respectively, thereby establishing wireless communication.

5. The automatic internet communication device as claimed in claim 1, wherein the mouthpiece is configured with a cutover switch, thereby enabling cutover of accepting or refusing on-line network communication link-up.
